(19) United States
(12) Patent Application Publication
(10) Pub. No.: US 2009/0097425 A1
(43) Pub. Date: Apr. 16, 2009

(54) RADIO LINK CONTROL OPERATIONS AND ENHANCED DUPLICATE DETECTION IN A WIRELESS RECEIVER

(75) Inventors: Mohammed Sammour, Montreal (CA); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/240,455

(22) Filed: Sep. 29, 2008

Related U.S. Application Data
(60) Provisional application No. 60/976,632, filed on Oct. 1, 2007.

(51) Int. Cl. H04W 8/00

(52) U.S. Cl. 370/310

(57) ABSTRACT

A radio link control (RLC) entity selectively stores part or parts of a received protocol data unit (PDU) or re-segmented PDU and selectively discards other parts of the received PDU, rather than simply either discarding the whole received PDU or storing the whole received PDU. The receiving RLC entity performs duplicate detection of received data as compared to data in an RLC buffer, selects the parts of the received PDU that will be discarded (if data is duplicated), discards the selected parts of the PDU, and stores the remaining parts of the PDU. Alternatively, data can be stored regardless of duplicate detection, and the buffer data is overwritten by the stored data.

### CROSS REFERENCE TO RELATED APPLICATIONS

This application claims the benefit of U.S. Provisional Application Ser. No. 60/976,632 filed on Oct. 1, 2007, which is incorporated by reference as if fully set forth.

### BACKGROUND

The long term evolution (LTE) of the Third Generation Partnership Protocol (3GPP) has defined a user-plane protocol stack architecture as shown in FIG. 1, which includes the Layer 2 (L2) sub layers: packet data convergence protocol (PDCP), radio link control (RLC) and medium access control (MAC).

The services and functions of the RLC sublayer include:

transfer of upper layer protocol data units (PDUs) supporting acknowledged mode (AM) or unacknowledged mode (UM), transparent mode (TM) data transfer, concatenation, segmentation, reassembly, in sequence delivery (reordering), duplicate detection, and error correction through automatic repeat request (ARQ) (cyclic redundancy check (CRC) provided by the physical layer).

The RLC sublayer may also provide segmentation according to the size of the transport block (TB). For example, the RLC service data unit (SDU) is segmented into variable sized RLC PDUs (which do not include any padding), when an RLC SDU does not fit entirely into the TB. Hence, the RLC will segment and/or concatenate the RLC SDUs so that the resulting PDUs fit within the total size of RLC PDU(s) indicated by a lower layer at the particular transmission opportunity notified by the MAC sublayer.

The RLC sublayer may also perform re-segmentation of RLC PDUs prior to retransmission if a PDU that needs to be retransmitted does not fit entirely into the new TB used for such retransmission. The number of re-segmentations is not limited.

Additional RLC capabilities include: concatenation of SDUs for the same radio bearer, in-sequence delivery of upper layer PDUs except at handover (HO) in the uplink, duplicate detection, protocol error detection and recovery, flow control between evolved NodeB (eNB) and user equipment (UE), SDU discard and reset.

In evolved universal mobile telecommunication system (UMTS) radio access network (E-UTRAN) (or LTE), a new re-segmentation functionality is supported, along with traditional segmentation. Thus, re-segmentation and reassembly of RLC PDUs will be supported (at least for AM data transfer) in addition to segmentation and reassembly of RLC SDUs.

FIG. 2 illustrates the processes of segmentation and re-segmentation in E-UTRAN (LTE).

In segmentation, the RLC SDU is segmented into RLC PDUs. The RLC PDUs are identified via a Sequence Number (SN) that is assigned on a per-PDU basis, i.e. a PDU SN. The PDU SN is included in the RLC header (not shown in FIG. 2). Segmentation of an SDU into PDUs may be done once (an SDU cannot be re-segmented again). Re-segmentation can be performed on RLC PDUs.

In such re-segmentation, the RLC PDU is segmented into PDU segments (i.e. sub-segments). The term ‘sub-segments’ refers to PDU segments (i.e. to the result of PDU re-segmentation). A sub-segment will be identified via two parameters, as illustrated in FIG. 2:

Segment Offset (SO): which indicates the (starting) position of the segment within the original PDU (e.g. in bytes)

Segment Length (SL): which indicates the length (size) of the segment (e.g. in bytes)

The Segment Offset (SO) field in the RLC header may directly indicate the SO in the RLC (or MAC) headers. Similarly, a Length Indicator (LI) field in the RLC header may directly indicate the SL. Alternatively, the Length Indications from the MAC layer (e.g. within the MAC header) may provide such information. A Re-segmentation flag in the RLC header may indicate the existence of a PDU segment.

SO and SL information in the various headers are used as inputs to the mechanisms described herein.

PDU re-segmentation can be applied multiple times (an unlimited number of times according to Release 8 of 3GPP). FIG. 3 illustrates an example of re-segmentation that is applied two times (or two levels). The left side of FIG. 3 illustrates that the 2nd sub-segment is larger than the 1st sub-segment; this might occur when the transport block (TB) size selected by lower layer is larger than the size of the PDU segment (i.e. the 1st sub-segment) that needs to be retransmitted. The right side of FIG. 3 illustrates that the 2nd sub-segment is smaller than the 1st sub-segment; this might occur for example when the transport block (TB) size selected by lower layer is smaller than the size of the PDU segment (i.e. the 1st sub-segment) that needs to be retransmitted.

In UTRAN (e.g. Release 6 or earlier), the detection of duplicate PDU segments is supported for AM RLC, and for UM RLC. In E-UTRAN (LTE), duplicate detection functionality is supported for AM RLC, and may also be supported for UM RLC.

The duplicate detection mechanisms employed in the earlier UTRAN releases, and specified in the current version of the E-UTRAN (LTE) RLC specification are based purely on performing a sequence number (SN) comparison between the received RLC PDU SN and the SN of packets stored in the reordering buffer. This approach worked because there was no re-segmentation.

Such duplicate detection techniques are not appropriate for E-UTRAN (LTE), since in E-UTRAN new functions such as re-segmentation will be employed. Therefore enhanced duplicate detection functionality is required for E-UTRAN, and for systems that support re-segmentation of RLC PDUs. Such an enhanced mechanism needs to be able to handle the impact of re-segmentation, and the possibility of receiving PDUs that have been re-segmented multiple times.

### SUMMARY

An RLC entity selectively stores part or parts of a received RLC PDU (or re-segmented PDU) in the RLC buffer and selectively discards other part(s) of the received PDU, rather than simply depending on the received RLC PDU SN for either discarding the entire received PDU or storing the entire received PDU in the RLC buffer.

A receiving RLC entity performs the following upon receiving an RLC PDU:
Selects the parts of the received PDU that will be discarded; Discards the selected parts of the PDU, and stores the remaining (other) parts of the PDU in the RLC buffer;

Alternatively, the receiving RLC entity performs the following upon receiving an RLC PDU:
Selects the parts of the received PDU that will be stored in the RLC buffer);
Stores the selected parts of the PDU in the RLC buffer, and discards the remaining (other) parts of the PDU

The above embodiment can be performed in any function of the RLC entity in general, such as in the RLC duplicate detection function, or the RLC reassembly function, or the RLC reordering function, or any other function.

### BRIEF DESCRIPTION OF THE DRAWINGS

A more detailed understanding may be had from the following description of embodiments, given by way of example and to be understood in conjunction with the accompanying drawings wherein:

FIG. 1 shows an LTE user-plane protocol stack;

FIG. 2 is an illustration of segmentation and re-segmentation in LTE;

FIG. 3 is an illustration of applying re-segmentation more than one time on a particular PDU; and

FIG. 4 is an illustration of various cases that can arise due to re-segmentation.

FIG. 5 shows an embodiment of a WTRU and its relevant components.

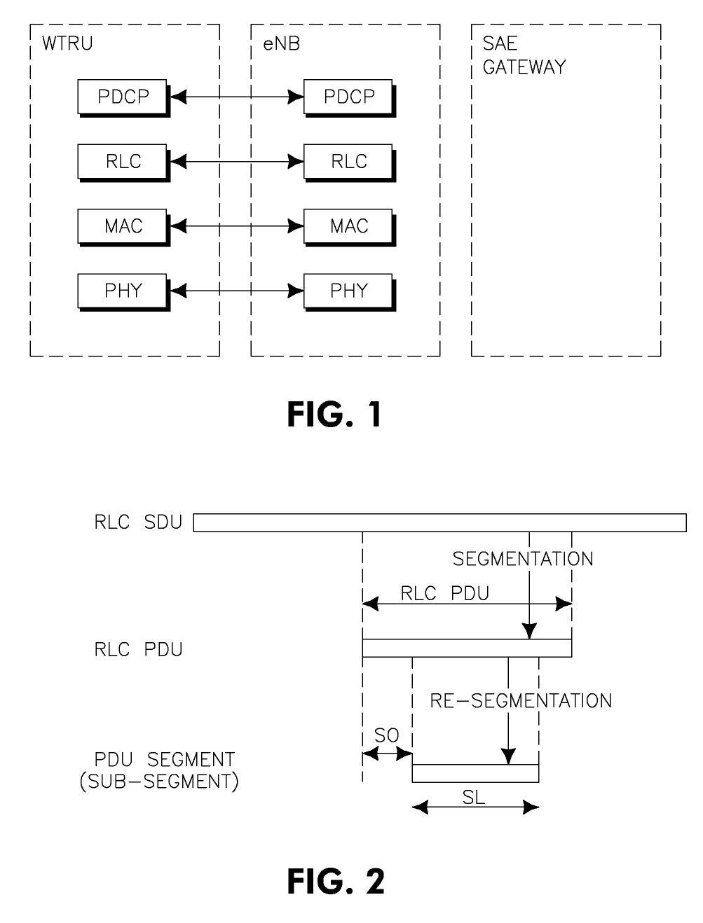

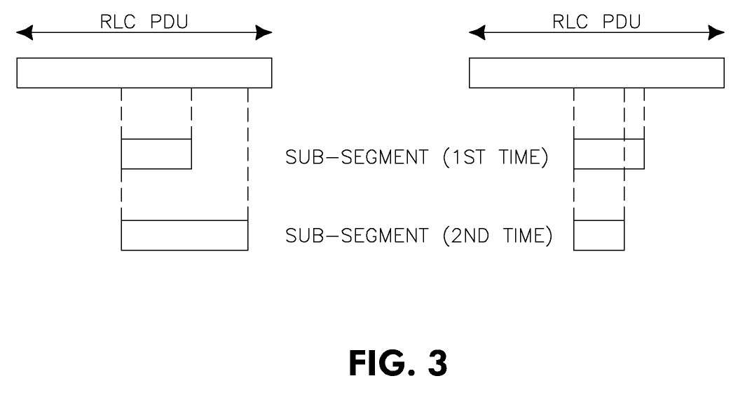

### DETAILED DESCRIPTION OF THE EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

When referred to hereafter, the terminology “duplicate detection” means the detection of duplicate data segments (for example, PDU segments) and may also be referred to as “duplicate avoidance” or “duplicate elimination”. The proposed duplicate detection functionality (e.g. its logic, or its steps) may be combined or performed in conjunction with other RLC functionalities such as the reordering functionality, or the reassembly functionality or the receive window functionality, or with any other functionality. A ‘Re-segmented PDU’, a ‘sub-segment’, or a ‘PDU Segment’ is the outcome of a PDU re-segmentation. When referred to hereafter, the terminology ‘buffer’ may be used interchangeably to mean a simple buffer, a ‘reassembly’ buffer or a ‘reordering’ buffer. When referred to hereafter, the terminology “new data” means data that does not “already exist” in the receiver's buffer. When referred to hereafter, the acronym “AMD” means “acknowledged mode data.” When referred to hereafter, the term packet refers to a PDU or a ‘PDU segment’. When referred to hereafter, the term “AMD PDU” refers to a (non re-segmented) PDU or to a ‘PDU Segment’. When referred to hereafter, the term “entire packet” refers to all data in the packet.

Unlike previous mechanisms that only utilized the PDU SN information, an enhanced RLC duplicate detection functionality may utilize any or all of the following information: Sequence Number (SN), Segment Offset (SO), and Segment Length (SL).

Determining whether some or all the data contained in the AMD PDU is already stored or exists (has been previously received) in the RLC buffer is done by utilizing SN, SO and SL information to determine (or compare or calculate) the relationship between the data received in the packet and the data stored in the RLC buffer (previously received data). Determining whether or not a received packet is a ‘Re-segmented PDU’ may be accomplished by checking a re-segmentation flag in the RLC header.

The receiving RLC entity will find the relationship by comparing the data ranges (boundaries) of the PDU parts that are stored in the buffer with the data range (e.g. SO and SL) communicated in the packet's header information (e.g. RLC or MAC headers).

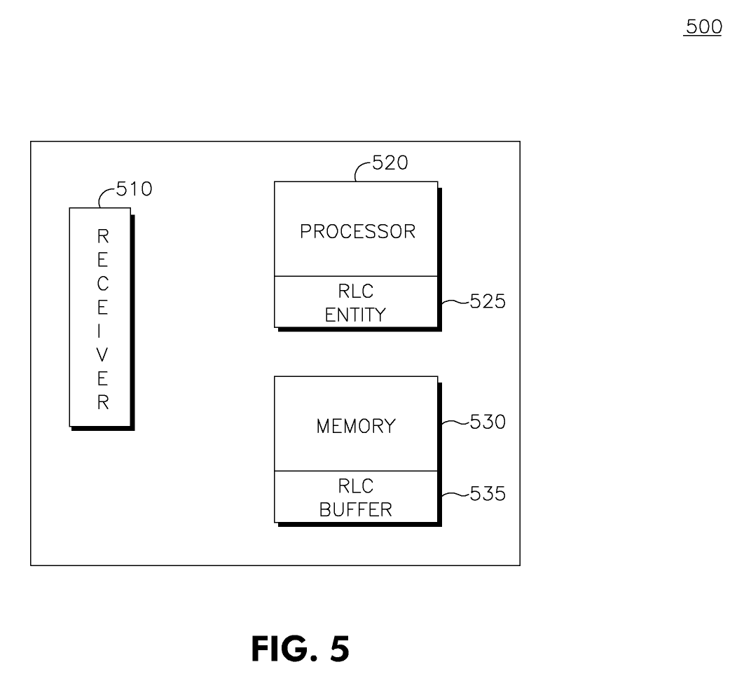

Referring to FIG. 5, upon reception of a packet (e.g. PDU or PDU segment) by the receiver 510, the receiving RLC entity 525, which is a virtual entity logically contained in and executed by the processor 520 (shown in a WTRU, but is also present in an eNB) performs the following:

Compares the data range specified by SN, SO, and SL (if available) of the packet with the data ranges of a packet (or packets) already stored in the RLC buffer 535, which is a virtual entity contained in memory 530 to determine if the data contained in the packet exists in the RLC buffer (was previously received).

If all of the data contained in the packet already exists (i.e., it has been previously successfully received) in the RLC buffer 535, then the RLC entity 525 discards the received packet;
Else if some data contained in the packet does not exist (i.e., it is new data because it was not previously successfully received) in the RLC buffer 535;
   then the RLC entity 525 only discards the data part that already exists in the RLC buffer 535 (i.e. RLC entity 525 stores new data in the RLC buffer 535).

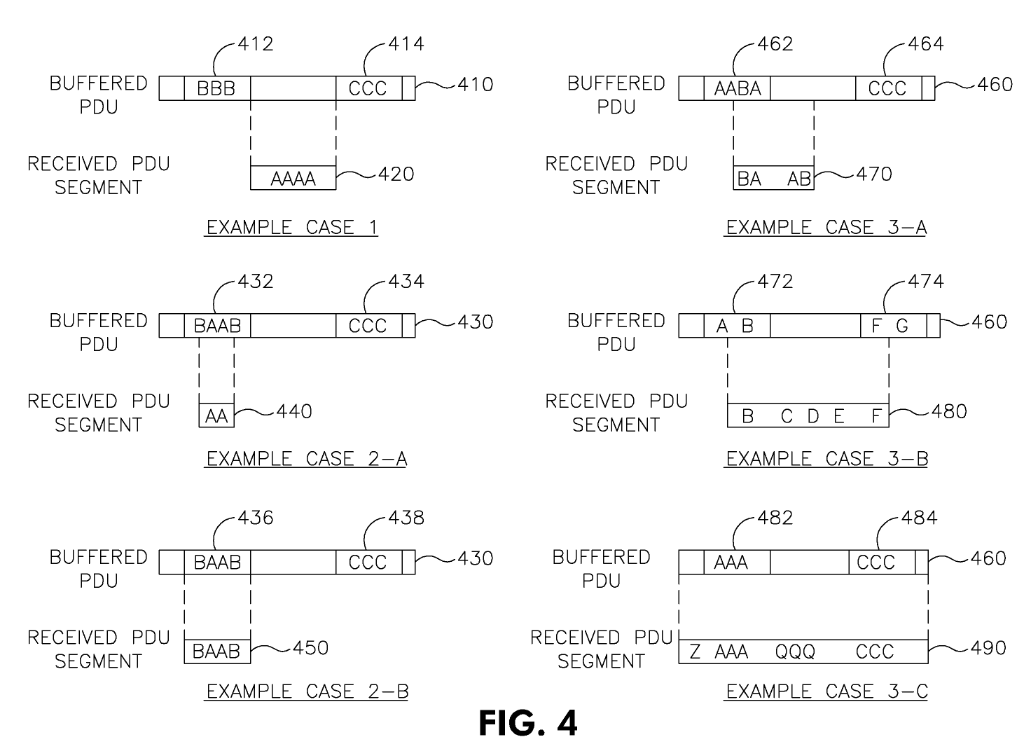

FIG. 4 illustrates various situations/cases that can arise along with the relationships between the received packet (e.g. RLC PDU or PDU segment) and the data stored in the RLC buffer (previously received data). The receiving RLC entity (e.g. in the WTRU or in the eNB) will determine if any of the data in the received packet has been previously received by determining, as described above, the relationship between the data received in the packet and the data stored in the RLC buffer (previously received data).

Depending on the (determined) relationship, the RLC entity performs one of the following:
Stores all the data in the received packet in the RLC buffer;
Discards all the data in the received packet;
Stores some of the data in the received packet in the RLC buffer, and discards the rest of the data (or vice versa, i.e. discards some, and stores the rest).

Referring to FIG. 4, Case 1 exemplifies the condition where the RLC buffer 410 has not previously received (and stored) any of the data contained in the received packet 420, the receiving RLC entity will store (i.e. will not discard) the data contained in the new packet 420 in the RLC buffer 410.

Case 2 (2-A or 2-B), illustrates the condition where all of the data contained in the received packet 440 has been previously received and stored in RLC buffer 430, the receiving RLC entity can either:
Discard the received packet 440, or
Store (overwrite) all of the received packet's data into the RLC buffer 430.

Case 3 (3-A, 3-B or 3-C) illustrates the situation where some (but not all) of the data contained in the received packet 470 has been previously received and stored in RLC buffer 460, the receiving RLC entity can either:
Store the received packet's data that is not already stored in the RLC buffer 460 and discard the rest of the received packet's data, or
Store (overwrite) all of the received packet's data in the RLC buffer 460.

In Case 3-A (similarly in 3-B, 3-C), the receiving RLC entity's reassembly function (selectively) combines the received PDU Segment 470 with existing PDU Segments (462 and 464) that are already stored in the RLC buffer 460.

However, storing all of the received packet's data (i.e. overwriting existing segments 462 and 464) in the RLC buffer 460 is also a viable option, since this will achieve the same result.

In contrast to the current state of the art whereby the receiving RLC entity simply either discards the received PDU in entirety or stores the received PDU in entirety depending on the received RLC PDU SN, the RLC entity utilizing enhanced duplicate detection may selectively store a part or parts of a received PDU and selectively discard (i.e. does not store) other part or parts of the received PDU. In each embodiment described below, the receiving RLC entity (e.g. in the UE or in the eNB) will determine if any of the data in the received packet has been previously received (already exists in the RLC buffer) by determining, as described above, the relationship between the data received in the packet and the data stored in the RLC buffer (previously received data).

In one embodiment, a receiving RLC entity performs the following upon receiving an RLC PDU:
Selects by utilizing SN, SO and SL information to determine (or compare or calculate) the relationship between the data received in the packet and the data stored in the RLC buffer (previously received data) the parts of the received PDU that will be discarded; and
   Discards the selected parts of the PDU, and stores the remaining (other) parts of the PDU in the RLC buffer.

In another embodiment, a receiving RLC entity performs the following upon receiving an RLC PDU or an RLC PDU Segment:
Selects by utilizing SN, SO and SL information to determine (or compare or calculate) the relationship between the data received in the packet and the data stored in the RLC buffer (previously received data) the parts of the received PDU that will be stored in the RLC buffer (those parts that have not been previously received); and
Stores the selected parts of the PDU in the RLC buffer, and discards the remaining (other) parts of the PDU (those parts that were previously received).

In another embodiment, when receiving an AMD PDU from a lower layer, the receiving side of an AM RLC entity performs as follows:
If an AMD PDU with the same SN already exists in the RLC buffer (some or all of the data has been previously received and stored):
   Then if all the data contained in the received AMD PDU already exists in the RLC buffer:
      Discard the received AMD PDU;
   Else (i.e. if some data contained in the received AMD PDU does not exist in the RLC buffer):
      Discard only the received AMD PDU data that already exists in the RLC buffer (i.e. store the new data in the RLC buffer).

In another embodiment, when receiving an AMD PDU from a lower layer, the receiving side of an AM RLC entity shall:
If an AMD PDU with the same SN already has data in the RLC buffer:
   If all the data contained in the received AMD PDU already exists in the RLC buffer:
      Discard the received AMD PDU;
   Else (i.e. if some data contained in the received AMD PDU does not exist in the RLC buffer):
      Store the received AMD PDU (i.e. over-write the RLC buffer with the data of the received AMD PDU).

In other words, if all the data contained in the newly received AMD PDU already exists in the RLC buffer, the receiving side of the AM RLC entity will discard the AMD PDU.

In another embodiment, when receiving an AMD PDU from a lower layer, the receiving side of an AM RLC entity performs as follows:
If an AMD PDU with the same SN already exists in the RLC buffer:
   Store the received AMD PDU (i.e. overwrite the buffer with the data of the received AMD PDU).

In this embodiment, the RLC receiver's operation is simplified by having it overwrite the data in the RLC buffer in all cases. Thus, the duplicate detection functionality may be eliminated from the RLC. In other words, the RLC will always store the received AMD PDU (i.e. overwrite the buffer with the data of the received AMD PDU) without performing duplicate detection.

In another embodiment, the AMD PDU is only stored in the RLC buffer (i.e. duplicate detection is not performed) if it is a re-segmented PDU. But when an AMD PDU is not a re-segmented PDU, duplicate detection is performed. This embodiment is described as follows:

When receiving an AMD PDU from a lower layer, the receiving side of an AM RLC entity performs as follows:
If an AMD PDU with the same SN already has data in the RLC buffer:
   If the received AMD PDU is not a re-segmented PDU:
      If the entire AMD PDU already exists in the buffer;
         Discard the received AMD PDU;
   Else (i.e. if the received AMD PDU is a re-segmented PDU):
      Store the received AMD PDU (i.e. over-write the RLC buffer with the data of the received AMD PDU).

In another embodiment, when receiving an AMD PDU from a lower layer, the receiving side of an AM RLC entity performs as follows:
If an AMD PDU with the same SN already has data in the RLC buffer:
   If the received AMD PDU is not a re-segmented PDU:
      If all of the AMD PDU's data is already stored in the RLC buffer);
         Discard the received AMD PDU
   Else if the received AMD PDU is a re-segmented PDU:
      If all the data contained in the re-segmented PDU is already stored in the RLC buffer:
         Discard the received AMD PDU;
      Else if some data contained in the re-segmented PDU does not exist in the RLC buffer:
         Discard only the AMD PDU data that already exists in the RLC buffer (i.e. store the new data).

In another embodiment, when receiving an AMD PDU from a lower layer, the receiving side of an AM RLC entity performs as follows:
If an AMD PDU with the same SN already has data in the RLC buffer:
   Discard only the received AMD PDU data that is already stored in the RLC buffer (i.e. store the new data).

Any of the above embodiments may be combined with the following:
when receiving an AMD PDU from a lower layer, the receiving side of an AM RLC entity performs the following:
   If an AMD PDU with the same SN has not been received before:
      Store the received AMD PDU.

One skilled in the art will recognize that the embodiments may be combined (integrated) with other functionalities, operations, or with other logic. For example, the embodiments may be performed in any function of the RLC entity in general, such as in the RLC duplicate detection function, or the RLC reassembly function, or the RLC reordering function, or any other function.

In order to limit the impact of re-segmentation on duplicate detection and reassembly operations, another embodiment relates to a restriction whereby a PDU or ‘PDU Segment’ can be re-segmented an additional time (i.e. for an additional level), but only if the resulting ‘PDU Segment’ is smaller or equal in size. A variant condition is that a RLC entity (e.g. in a device) will create and/or transmit a second PDU Segment (using data from an underlying PDU) only if all data to be included in the second PDU Segment is a subset (was fully included) within a first PDU Segment created and/or transmitted earlier. Another variant condition is that a RLC entity (e.g. in a device) will create and/or transmit a second PDU Segment (using data from an underlying PDU) only if the second PDU Segment is created using data from a first PDU Segment created and/or transmitted in the most recent round of PDU re-segmentation. Yet another variant condition is that a RLC entity (e.g. in a device) will create and/or transmit a second PDU Segment only if the second PDU Segment's SO is equal to or greater than a first PDU Segment's SO and the second PDU Segment's SL is equal to or less than the first PDU Segment's SL, wherein the first PDU Segment is any PDU Segment created and/or transmitted earlier. This restriction can prevent situations such as Case 3 in FIG. 4 from arising, and can simplify aspects such as receive buffer operations, duplicate detection, reassembly, and reordering.

Hence, the transmitting RLC entity performs an additional re-segmentation of a first ‘PDU Segment’ when the resulting subsequent ‘PDU Segment’ is (or can be) shorter (i.e. a sub-set) than the first ‘PDU Segment’.

Another possible restriction is that once a re-segmentation is applied on a given PDU, the ‘full’ PDU or ‘original’ PDU cannot be retransmitted again at a subsequent time.

As described above, removing the duplicate detection functionality from the RLC can simplify overall RLC operations. In another embodiment, simplification may be achieved, by integrating one or more of the aforementioned embodiments for duplicate detection, within other RLC functions. For example, the reassembly function may perform any of the duplicate detection embodiments.

Those skilled in the art will recognize that the previous embodiments are applicable to other data units capable of re-segmentation similar to a ‘PDU Segment’, where the term ‘PDU’ is defined to encompass any RLC output packet, including a ‘PDU Segment’. In this case, it may be necessary to determine if a received RLC PDU is or is not a sub-segment.

Those skilled in the art will recognize that the above embodiments are also applicable when duplicate detection is performed in conjunction with other functions, such as, for example, reassembly, reordering, or window operations.

Those skilled in the art will recognize that the above embodiments are applicable when there are changes or modifications to the RLC sub-layer's functionality, for example, if SDU re-segmentation is employed instead of PDU re-segmentation. The same concepts illustrated for PDU re-segmentation can be reused in the case of SDU re-segmentation (e.g. the SO will indicate the (starting) position of the segment within the original SDU (e.g. in bytes), and the SL will indicate the length of the segment (e.g. in bytes). Also, the embodiments may apply if a different mechanism is used for re-segmentation (other than the segment offset/length approach), for example, when it is possible to find/calculate SO and SL from the indicated segmentation information.

The above embodiments are applicable even if additional functionalities are added to the RLC sub-layer or if they are used in another RLC mode, such as UM (unacknowledged mode), in addition to the AM RLC mode. While the above embodiments are described in terms of RLC PDUs (or RLC packets) and specifically AMD PDUs (or AMD packets) they are equally applicable to other types of RLC PDUs such as UM PDUs (or UM packets).

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed:

1. A method for enhanced duplicate detection comprising:
receiving RLC PDUs and RLC PDU segments; and
determining if at least a portion of the RLC PDUs or RLC PDU segments has been successfully received by utilizing the sequence number (SN), segment offset (SO), and segment length (SL) information.

2. The method of claim 1 wherein the enhanced duplicate detection is performed in at least one of: a RLC PDU duplicate detection function, a RLC PDU re-assembly function, a RLC PDU reordering function, and a RLC SDU re-assembly function.

3. The method of claim 2 wherein a first RLC function and a second RLC function are performed sequentially in any order.

4. The method of claim 2 wherein a first RLC function and a second RLC function are performed in parallel.

5. The method of claim 2 wherein at least two of the RLC functions are performed in parallel and at least two of the RLC functions are performed in sequence.

6. The method of claim 1 wherein a received RLC PDU or RLC PDU segment is an RLC acknowledged mode data (AMD) PDU or RLC AMD PDU segment or an RLC unacknowledged mode data (UMD) PDU or an RLC UMD PDU segment.

7. The method of claim 6 wherein at least one of SN, SO or SL is used to determine a first data range of the received RLC PDU or RLC PDU segment.

8. The method of claim 7 further comprising comparing the first data range with a second data range comprising data previously stored in a RLC buffer.

9. The method of claim 8 further comprising discarding the received RLC PDU or RLC PDU segment if the received RLC PDU or RLC PDU segment has previously been successfully received.

10. The method of claim 8 further comprising storing the received RLC PDU or RLC PDU segment if the received RLC PDU or RLC PDU segment has previously been successfully received.

11. The method of claim 8 further comprising storing new data from the received RLC PDU or RLC PDU segment and discarding data in the received RLC PDU or RLC PDU segment that has already been successfully received.

12. The method of claim 8 further comprising storing all of the received RLC PDU or RLC PDU segment if a portion of the received RLC PDU or RLC PDU segment has not been previously received.

13. The method of claim 6 further comprising:
determining that the received RLC PDU or RLC PDU segment has a SN that was previously stored;
if all data of the received RLC PDU or RLC PDU segment was previously stored,
discarding the received RLC PDU or RLC PDU segment
Else if some data of the received RLC PDU or RLC PDU segment was previously stored,
discarding the previously stored data from the received RLC PDU or RLC PDU segment.

14. The method of claim 6 further comprising:
determining that the received RLC PDU or RLC PDU segment has a SN that was previously stored;
discarding the received RLC PDU or RLC PDU segment if all data of the received RLC PDU or RLC PDU segment was previously stored;
storing the received RLC PDU or RLC PDU segment if all data of the received RLC PDU or RLC PDU segment was not previously stored.

15. The method of claim 6 further comprising:
storing the received RLC PDU or RLC PDU segment if the received RLC PDU or RLC PDU segment has a SN that was previously stored.

16. The method of claim 6 further comprising:
if the received RLC PDU has a SN that was previously stored and
if the received RLC PDU is not a RLC PDU segment and
if all data in the RLC PDU has previously been stored,
discarding the RLC PDU; and
if the RLC PDU is a RLC PDU segment, storing the RLC PDU segment.

17. The method of claim 6 further comprising:
if the received RLC PDU has a SN that was previously stored and
if the RLC PDU is not a RLC PDU segment and
if all data in the RLC PDU has previously been stored,
discarding the RLC PDU
if the RLC PDU is a RLC PDU segment and
if all data in the RLC PDU segment has previously been stored,
discarding the RLC PDU segment; and
if all data in the RLC PDU segment has not previously been stored,
discarding the previously stored data from the received RLC PDU segment.

18. The method of claim 6 further comprising:
discarding previously stored data from the received RLC PDU or RLC PDU segment, if the received RLC PDU or RLC PDU segment has a SN that was previously stored.

19. The method of claim 6 further comprising:
storing the RLC PDU or RLC PDU segment, if the received RLC PDU or RLC PDU segment has a SN that was not previously stored.

20. A method for re-segmenting a PDU segment comprising re-segmenting a first PDU segment only if a resulting PDU segment is shorter than or equal to the first PDU segment.

21. A method for re-segmenting a PDU segment comprising creating or transmitting a second PDU segment only if all data to be included in the second PDU segment is a subset of a first PDU segment created or transmitted previously.

22. A method for re-segmenting a PDU segment comprising creating or transmitting a second PDU segment only if the second PDU segment is created using data from a PDU segment created or transmitted in a most recent round of PDU re-segmentation.

23. A method for re-segmenting a PDU segment comprising creating or transmitting a second PDU segment only if the second PDU segment's SO is equal to or greater than a first PDU segment's SO and the second PDU segment's SL is equal to or less than the first PDU segment's SL, wherein the first PDU segment is at least one of a previously created segment or a transmitted segment of the PDU.

24. The method of claim 6 further comprising:
determining that the received RLC PDU or RLC PDU segment has a SN that was previously stored;
discarding the received RLC PDU or RLC PDU segment if all data of the received RLC PDU or RLC PDU segment was previously stored; or
if a portion of the data of the received RLC PDU or RLC PDU segment was previously stored, discarding the portion.

25. A method for RLC PDU re-transmission comprising retransmitting a PDU only if the PDU was not previously segmented.

26. A wireless transmit/receive unit (WTRU) comprising:
a receiver configured to receive a radio link control (RLC) protocol data unit (PDU);
the receiving RLC entity configured to select the parts of the received PDU that will be discarded;
the receiving RLC entity configured to discard the selected parts of the PDU; and
the receiving RLC entity configured to store the remaining parts of the PDU in a RLC buffer.

27. A wireless transmit/receive unit (WTRU) comprising:
a receiver configured to receive a radio link control (RLC) protocol data unit (PDU);
the receiving RLC entity configured to select the parts of the received PDU that will be stored in a RLC buffer;
the receiving RLC entity configured to stores the selected parts of the PDU in the RLC buffer; and
a receiving RLC entity configured to discard the remaining parts of the PDU.

28. A wireless transmit/receive unit (WTRU) comprising:
a receiving radio link control (RLC) entity configured to receive RLC PDUs and RLC PDU segments; and
the receiving RLC entity configured to determine if at least a portion of the RLC PDUs or RLC PDU segments has already been successfully received by utilizing the sequence number (SN), segment offset (SO), and segment length (SL) information.

29. The WTRU of claim 28, wherein the receiving RLC entity configured to perform enhanced duplicate detection in at least one of: a RLC PDU duplicate detection function, a RLC PDU re-assembly function, a RLC PDU reordering function, and a RLC SDU re-assembly function.

30. The WTRU of claim 29 further comprising a receiving RLC entity configured to perform a first RLC function and a second RLC function sequentially in any order.

31. The WTRU of claim 29 further comprising a receiving RLC entity configured to perform a first RLC function and a second RLC function in parallel.

32. The WTRU of claim 29 further comprising a receiving RLC entity configured to perform at least two of the RLC functions in parallel and at least two of the RLC functions in sequence.

33. The WTRU of claim 28, wherein a received RLC PDU is an RLC acknowledged mode data (AMD) PDU or RLC AMD PDU segment or an RLC unacknowledged mode data (UMD) PDU or an RLC UMD PDU segment.

34. The WTRU of claim 33 further comprising a receiving RLC entity configured to use at least one of SN, SO and SL to determine a first data range of the received RLC PDU or RLC PDU segment.

35. The WTRU of claim 34 further comprising a receiving RLC entity configured to compare the first data range with a second data range comprising data previously stored in a RLC buffer.

36. The WTRU of claim 35 further comprising a receiving RLC entity configured to discard the received RLC PDU or RLC PDU segment if the received RLC PDU or RLC PDU segment has previously been successfully received.

37. The WTRU of claim 35 further comprising a receiving RLC entity configured to store the received RLC PDU or RLC PDU segment if the received RLC PDU or RLC PDU segment has previously been successfully received.

38. The WTRU of claim 35 further comprising a receiving RLC entity configured to store new data from the received RLC PDU or RLC PDU segment and discarding data in the received RLC PDU or RLC PDU segment that has already been successfully received.

39. The WTRU of claim 35 further comprising a receiving RLC entity configured to store all of the received RLC PDU or RLC PDU segment if a portion of the received RLC PDU or RLC PDU segment has not been previously received.

40. The WTRU of claim 33 further comprising a receiving RLC entity configured to
determine that the received RLC PDU or RLC PDU segment has a SN that was previously stored;
if all data of the received RLC PDU or RLC PDU segment was previously stored,
discard the received RLC PDU or RLC PDU segment
Else if some data of the received RLC PDU or RLC PDU segment was previously stored,
discard the previously stored data from the received RLC PDU or RLC PDU segment.

41. The WTRU of claim 33 further comprising:
a receiving RLC entity configured to determine that the received RLC PDU or RLC PDU segment has a SN that was previously stored;
a receiving RLC entity configured to discard the received RLC PDU or RLC PDU segment if all data of the received RLC PDU or RLC PDU segment was previously stored;
a receiving RLC entity configured to store the received RLC PDU or RLC PDU segment if all data of the received RLC PDU or RLC PDU segment was not previously stored.

42. The WTRU of claim 33 further comprising a receiving RLC entity configured to store the received RLC PDU or RLC PDU segment if the received RLC PDU or RLC PDU segment has a SN that was previously stored.

43. The WTRU of claim 33 further comprising
a receiving RLC entity configured to determine
if the received RLC PDU has a SN that was previously stored and
if the received RLC PDU is not a RLC PDU segment and
if all data in the RLC PDU has previously been stored,
discard the RLC PDU; and
if the RLC PDU is a RLC PDU segment, store the RLC PDU segment.

44. The WTRU of claim 33 further comprising:
a receiving RLC entity configured to determine if the received RLC PDU has a SN that was previously stored and
if the RLC PDU is not a RLC PDU segment and
if all data in the RLC PDU has previously been stored,
discard the RLC PDU
if the RLC PDU is a RLC PDU segment and
if all data in the RLC PDU segment has previously been stored,
discard the RLC PDU segment; and
if all data in the RLC PDU segment has not previously been stored,
discard the previously stored data from the received RLC PDU segment.

45. The WTRU of claim 33 further comprising a receiving RLC entity configured to discard previously stored data from the received RLC PDU or RLC PDU segment, if the received RLC PDU or RLC PDU segment has a SN that was previously stored.

46. The WTRU of claim 33 further comprising a receiving RLC entity configured to store the RLC PDU or RLC PDU segment, if the received RLC PDU or RLC PDU segment has a SN that was not previously stored.

47. The WTRU of claim 33 further comprising:
a receiving RLC entity configured to determine that the received RLC PDU or RLC PDU segment has a SN that was previously stored;
a receiving RLC entity configured to discard the received RLC PDU or RLC PDU segment if all of the received RLC PDU or RLC PDU segment was previously stored; or
a receiving RLC entity configured to discard a previously received data from the received RLC PDU or RLC PDU segment if some of the received RLC PDU or RLC PDU segment was previously stored.

48. A wireless transmit/receive unit (WTRU) comprising:
an RLC entity configured to re-segment a first PDU segment only if a resulting PDU segment is shorter than or equal to the first PDU segment.

49. A wireless transmit/receive unit (WTRU) comprising:
an RLC entity configured to create or transmit a second PDU segment only if all data to be included in the second PDU segment is a subset of a first PDU segment created or transmitted previously.

50. A wireless transmit/receive unit (WTRU) comprising:
an RLC entity configured to create or transmit a second PDU segment only if the second PDU segment is created using data from a PDU segment created or transmitted in a most recent round of PDU re-segmentation.

51. A wireless transmit/receive unit (WTRU) comprising:
an RLC entity configured to create or transmit a second PDU segment only if the second PDU segment's SO is equal to or greater than a first PDU segment's SO and the second PDU segment's SL is equal to or less than the first PDU segment's SL, wherein the first PDU segment is at least one of a previously created segment or a transmitted segment of the PDU.
